(19) United States
(12) Patent Application Publication
(10) Pub. No.: US 2025/0344695 A1
(43) Pub. Date: Nov. 13, 2025

(54) METHOD FOR PEST CONTROL

(71) Applicant: The United States of America, as represented by the Secretary of Agriculture, Washington, DC (US)

(72) Inventor: Yong-Biao Liu, Salinas, CA (US)

(21) Appl. No.: 19/184,123

(22) Filed: Apr. 21, 2025

Related U.S. Application Data
(60) Provisional application No. 63/643,948, filed on May 8, 2024.

(51) Int. Cl. A01N 29/04; A01N 25/18; A01P 7/04

(52) U.S. Cl. CPC A01N 29/04; A01N 25/18; A01P 7/04

(57) ABSTRACT

Compositions and methods of pest control by fumigation employing chlorobenzene are described. Fumigation compositions and methods to effectively control insect and mite pests in agriculture, industry and commerce including confused flour beetle, rice weevil, navel orange worm, spotted wing drosophila, western flower thrips, eastern subterranean termite or ham mites are described.

### CROSS-REFERENCE TO RELATED APPLICATIONS

This application claims the benefit of U.S. Provisional Application No. 63/643,948, titled “A METHOD FOR PEST CONTROL” filed May 8, 2024, which is incorporated herein by reference in its entirety.

### FIELD OF THE INVENTION

The inventions described herein relate to pest control via fumigation methods and compositions to control harmful pests.

### BACKGROUND OF THE INVENTION

The process of fumigation employs pest control for the killing of harmful organisms by completely filling an enclosed space with gaseous fumigant(s). The goal of the fumigation process is ideally to use a chemical to kill or passivate targeted pests without damaging products which are fumigated. Fumigants used currently for postharvest pest control include methyl bromide, sulfuryl fluoride, phosphine, ethyl formate, sulfur dioxide, etc.

The harmful effects of known fumigants are difficult to avoid, so fumigation is conducted by carefully avoiding human contact with fumigants. Post operation ventilation of the area is a critical safety aspect of fumigation. The environmental effects of fumigants is another major concern. Sulfuryl fluoride is neurotoxic and a potent greenhouse gas but is widely used as a fumigant insecticide for structure fumigations to control termites and stored product insects. Methyl bromide for example is far more destructive to stratospheric ozone than chlorine. Phosphine is a widely used fumigant. However, phosphine is unable to kill all stages of insects in a short period when used at acceptable concentrations.

There is a need to find safer and effective alternative fumigants to replace or supplement existing ones which have proven to have serious disadvantages.

### SUMMARY OF THE INVENTION

Described herein are methods (and compositions) in various embodiments of using chlorobenzene to treat a pest infestation by fumigating a room, substrate, soil or object with an effective concentration of chlorobenzene vapor.

Exemplified treatments of pests by fumigation with chlorobenzene include, the confused flour beetle, rice weevil, navel orange worm, spotted wing drosophila, western flower thrips, ham mites, or eastern subterranean termite.

Methods described employ fumigation vapors which consist essentially of chlorobenzene as the sole active ingredient.

Methods described employ fumigation vapors which consist essentially of chlorobenzene as the sole active ingredient to maintain the effective amount of chlorobenzene quantity of at least 25 μl/l of the enclosed space. The effective amount of chlorobenzene quantity can range between 5 μl/l to 55 μl/l of the enclosed space.

In one embodiment, a fumigation mixture consisting of chlorobenzene in air is described wherein the concentration of chlorobenzene is about 100 ppm to 15000 ppm in air.

In one embodiment, a fumigation mixture consisting of chlorobenzene in air is described wherein the concentration of chlorobenzene is about 200 ppm to 5000 ppm.

In one embodiment, a fumigation mixture consisting of chlorobenzene in air is described wherein the fumigant includes a carrier.

In one embodiment, a fumigation mixture consisting of chlorobenzene in air is described wherein the carrier is a solid or liquid carrier.

### BRIEF DESCRIPTION OF THE DRAWINGS

FIG. 1 shows an exemplified embodiment of treating a silo loaded with grain with chlorobenzene.

FIG. 2 shows an exemplified embodiment of treating a fire ant colony with chlorobenzene.

FIG. 3 shows another exemplified embodiment 50 of treating harvested fruits in boxes in a cooler with chlorobenzene

FIG. 4 shows images of six exemplified pests treated in chlorobenzene fumigation treatments.

FIG. 5 shows photographs of a chlorobenzene fumigation experiment set up in a 60-liter chamber.

FIG. 6 shows another exemplified embodiment 50 of treating harvested fruits in boxes in a cooler with chlorobenzene.

### DETAILED DESCRIPTION

Described herein are compositions and methods comprising a step of releasing chlorobenzene at or near a habitat of an arthropod pest to allow chlorobenzene as a liquid or slurry or other suitable composition to vaporize and maintain a certain vapor concentration in the pest habitat for an effective length of time necessary to achieve effective control of the pest. The habitat may include various sealable enclosures such as shipping containers, chambers, silo bags, tents, sealed tarpaulin, greenhouses, field tunnels, and other sealable rigid and flexible structures and non-sealable habitats such as soil. For fumigation in an enclosure, preferably, the method also comprises a step of circulating air to disperse gaseous chlorobenzene in the enclosure. For fumigation against soil dwelling pests such as ants, termites, and root feeding insects, chlorobenzene is released in soil near or at pest habitats. As chlorobenzene vapor is 3.9 times heavier as compared with air, it tends to sink downward and, therefore, is expected to sink through soil pores to reach insect habitats such as tunnels, nests, galleries of ants and termites to kill soil dwelling insects. Chlorobenzene dose and treatment duration may differ depending on susceptibility of pest species. The methods and compositions provide an effective and environmentally friendly alternative fumigation method for postharvest pest control, soil pest control, and pest control in other situations.

Also provided herein are methods of fumigating an area or one or more objects attacked by pests by a method of exposing the area or object to vapors of chlorobenzene wherein chlorobenzene is essentially the sole active ingredient. The fumigation process is continued for a time sufficient to effectively expose target pests to chlorobenzene and control them. In various embodiments, the fumigation process employs a concentration of chlorobenzene that is effective in controlling pests. In one embodiment, fumigation operations are carried out in an enclosed space or otherwise to ensure a sufficient concentration and period of contact of the chlorobenzene fumigant with the infesting organisms.

In one embodiment, an ovicidal method of fumigating an enclosed space exemplified by a room, a substrate, soil or object attacked by pests, is carried out by exposing the room, substrate, soil or object to a vapor or gas comprising chlorobenzene to destroy insect eggs.

In various embodiments of the claims described herein, it has been discovered that matter infested with pests is advantageously fumigated and the pest organisms controlled by fumigation with chlorobenzene. In one embodiment, pests are advantageously fumigated and the pest organisms controlled by fumigation with vapor compositions consisting essentially of chlorobenzene. In one embodiment, pests are advantageously fumigated and the pest organisms controlled by fumigation with vapor compositions consisting of chlorobenzene.

In various aspects, grain and its milled products and other matter and foodstuffs may be fumigated with or exposed to the vapors of chlorobenzene to control pests.

In various aspects described herein, fumigation with chlorobenzene can be conducted, or used within a building or under a barrier or cover to control the application of fumigant to its desired target. The fumigation can be conducted on soil and fields outside buildings using a cover such as a tarp, polymeric sheets or membranes to control the area, volume, concentration, temperature, light and other conditions to effectively conduct the process of fumigation, In various aspects ambient locations, a substrate, soil or objects may be fumigated with or exposed to the vapors of chlorobenzene to control pests.

Chlorobenzene is a colorless organic compound with the formula C₆H₅CI consisting of a benzene ring with a chlorine atom bonded to it. Chlorobenzene degrades rapidly in air, water, and soil; it is not expected to bioconcentrate. Biodegradation of chlorobenzene is rapid, leaving no detectable residues after 1 or 2 weeks. Adaptation is also rapid (Tabak et al. 1981) It is primarily used industrially as an intermediate in rubber product production and solvent. It was used in the past to synthesize the pesticide DDT. It is practically insoluble in water (water solubility: 466.3 mg/L). It is flammable with a flash point of 27-29.4° C. It has a vapor pressure of 11.7 mmHg at 20° C. Its vapor density is 3.9 relative to air (air=1). The lower explosive limit of chlorobenzene is 1.3% and upper explosive limit is 7.1%. It is reported to be non-carcinogenic and has a very low oral and dermal toxicity (EPA category 4). The OSHA exposure limit is 75 ppm for an 8-hour workday and 40-hour work week.

In one embodiment, fumigation is carried out with chlorobenzene below its explosive limit. In one embodiment, fumigation is carried out wherein fumigation vapors are consisting of chlorobenzene and a carrier gas. In one embodiment, fumigation is carried out wherein fumigation vapors are consisting essentially of chlorobenzene. In one embodiment, fumigation is carried out wherein fumigation vapors consisting essentially of chlorobenzene vapors mixed with ambient air and impurities ordinarily associated therewith commercially available product.

In one aspect, a method of fumigation comprises of the steps of releasing chlorobenzene liquid in a sealable or partially sealable enclosure, space or area to allow it to vaporize and maintain an effective vapor concentration of chlorobenzene for a certain length of time necessary to kill a pest. The length of time required is adjusted based on temperature, concentration and target pests of the fumigation method.

In one embodiment, a fumigation mixture is described and method of using it to treat pests consisting of chlorobenzene in air wherein the concentration of chlorobenzene is about 100 ppm to 15000 ppm in air.

In one embodiment, a fumigation mixture is described and method of using it to treat pests consisting of chlorobenzene in air wherein the concentration of chlorobenzene is about 200 ppm to 5000 ppm.

In one embodiment, a fumigation mixture is described and method of using it to treat pests consisting of chlorobenzene in air wherein the fumigant includes a carrier.

In one embodiment, a fumigation mixture consisting of chlorobenzene in air is described and method of using it to treat pests wherein the carrier is a solid or liquid carrier.

After fumigation is completed the sealed enclosure, space or area is optionally unsealed or aerated by circulating air to disperse chlorobenzene vapor throughout the enclosure and penetrate products which were fumigated.

In one aspect, fumigation operations are carried out in an enclosed space or space with a barrier to prevent fumigant vapors from moving beyond the barrier. The barrier is exemplified by a paper, foil, film or like material made of a synthetic or natural polymer, metal or other suitable material which can be used in the form of a tent that is sealed. Other means such as a sealing tape or resin can be applied to seal holes, gaps, cracks, and other sources of leaks to contain the fumigant within the enclosed space of the barrier are employed by those skilled in the art.

In one aspect, fumigation with chlorobenzene compositions described herein are carried out wherein the temperature is about 32° F. In one aspect, fumigation with chlorobenzene compositions described herein are carried out wherein the temperature is about 60° F. In one aspect, fumigation with chlorobenzene compositions described herein are carried out wherein the temperature is about 75° F. In one aspect, fumigation with chlorobenzene compositions described herein are carried out wherein the temperature is about 90° F. In one aspect, fumigation with chlorobenzene compositions described herein are carried out wherein the temperature is about 95° F. In one aspect, fumigation with chlorobenzene compositions described herein are carried out wherein the temperature is about 100° F. In one aspect, fumigation with chlorobenzene compositions described herein are carried out wherein the temperature is about 110° F. In one aspect, fumigation with chlorobenzene compositions described herein are carried out wherein the temperature is about 120° F.

In various embodiments of the methods described herein, the fumigation process is done to ensure a sufficient period of contact of the chlorobenzene fumigant composition with the infesting organisms. In some preferred embodiments, chlorobenzene fumigant is in a liquid state placed in a space with the infesting organisms or pests for fumigation. The chlorobenzene liquid due to its vapor pressure spontaneously producing vapor for fumigation of infesting organisms and producing an effective amount of fumigant concentration in an enclosed space to control the infesting organisms or pests. In some embodiments vapor production from the liquid is enhanced by raising the temperature of the chlorobenzene liquid. In some embodiments of the fumigation process, air or an inert gas is bubbled through the chlorobenzene liquid to enhance vaporization. In some embodiments of the fumigation process, an inert gas or air is passed over the liquid surface optionally with raising the temperature of the chlorobenzene to produce an effective amount of vapor for fumigation of infesting organisms or pests. In some embodiments, chlorobenzene fumigant is combined with an absorbent carrier having absorbed therein the chlorobenzene volatile fumigant. The absorbent carrier can be a natural polymer (such as cellulose), synthetic polymer or carriers exemplified by materials such as clays, laminates, cellulosic and/or rubber matrices, synthetic polymer matrices, or the like.

In one embodiment, fumigation is carried out with chlorobenzene in a storage space or enclosed space for goods and materials. In other embodiments, fumigation is carried out with chlorobenzene wherein the storage space is a shipping container, fumigation chamber, tent, archive, tunnel, vault, residential space, hotel room, granary, or cellar.

In one embodiment fumigation is carried out with an effective amount of chlorobenzene fumigant for a period ranging from 1 to 240 hours. In one embodiment fumigation is carried out with chlorobenzene for 120 hours, in one embodiment fumigation is carried out with chlorobenzene for 96 hours, in one embodiment fumigation is carried out with chlorobenzene for 72 hours, in one embodiment fumigation is carried out with chlorobenzene for 48 hours, in one embodiment fumigation is carried out with chlorobenzene for 24 hours, in one embodiment fumigation is carried out with chlorobenzene for 10 hours, in one embodiment fumigation is carried out with chlorobenzene for 8 hours, in one embodiment fumigation is carried out with chlorobenzene for 6 hours, in one embodiment fumigation is carried out with chlorobenzene for 3 hours, in one embodiment fumigation is carried out with chlorobenzene for 1 hour.

In one embodiment chlorobenzene fumigant is applied to soil by setting over the soil a vapor barrier exemplified by a polymeric film to form a vapor barrier between the fumigant-treated soil and the atmosphere to at least partially contain and maintain an effective concentration of the chlorobenzene fumigant. In one embodiment, chlorobenzene fumigant is applied according to the methods and compositions described herein without employing a vapor barrier to the soil being treated.

In one embodiment chlorobenzene fumigant is injected into soil to allow chlorobenzene vapor to seep down through soil pores and cracks by gravity into insect habitats such as nests and tunnels to control soil dwelling insects.

In one embodiment chlorobenzene fumigation is employed for the fumigation of an enclosed space. An exemplified method is fumigation of containerized cargo described as follows. A tarpaulin is placed over the single cargo container unit or multiple container units that are being fumigated. The cargo is arranged within the container in a manner such that the gas fumigant effectively circulates and penetrates the stored substances. A series of fans are introduced inside of the container, in order to create a flow of the fumigant. After the fans are placed, gas introduction lines are positioned behind the fans through the main rear doors of the container. One or more gas sampling tubes are placed in specific locations within the bulk containerized cargo and are used to actively monitor the concentration of the fumigant within the cargo during the fumigation process. The containers are typically large shipping containers, however, the tarpaulin method can be used with smaller containers. Once the fans, sampling tubes, and introduction lines are positioned, one or more tarpaulins are simply draped over the cargo containers and sealed along the ground through either loose or wet sand, sand snakes, water snakes, weights, adhesives, or any other suitable sealing means. After the tarpaulin is sealed, the amount (typically by weight) of chlorobenzene fumigant required is calculated based on the contained volume. Once the amount is determined, in one embodiment, chlorobenzene vapor is caused to flow through at least one introduction line into the contained volume by using a vaporizer outside a shipping container and circulating chlorobenzene vapor into the container and hence through the open doors of the tarpaulin covered shipping containers. The fumigant is allowed to flow into the tarpaulin confined space until the calculated vapor amount has been introduced. The fumigant concentration level is subsequently sampled, typically using one or more sampling tubes, to determine whether a predetermined concentration level has been achieved throughout the contained volume. If the concentration level is low, then additional fumigant may be introduced. Conversely, if the concentration level is high, then the fumigation time may be reduced. The fumigation process steps in preferred embodiments employ approved equipment, including air purifying respirators, direct read gas detection devices, and continuous real-time gas monitoring devices. Upon completion of the fumigation phase, the volume is aerated through a method that is in accordance with treatment guidelines and/or the Fumigator's PPQ (Plant Protection and Quarantine) compliance requirements. The method of aeration typically involves placing fans and exhaust ducts underneath the tarpaulin so that the fumigant is evacuated into the atmosphere in a controlled manner. Once the container is sufficiently aerated, for example to less than the 75 ppm OSHA exposure limit for chlorobenzene, the tarpaulin is removed, and the cargo is subsequently released.

In one embodiment chlorobenzene is mixed with one or more carriers to form a semi-liquid paste and the paste is applied to the surfaces of wood structures to control insects such as drywood termites in the wood structures.

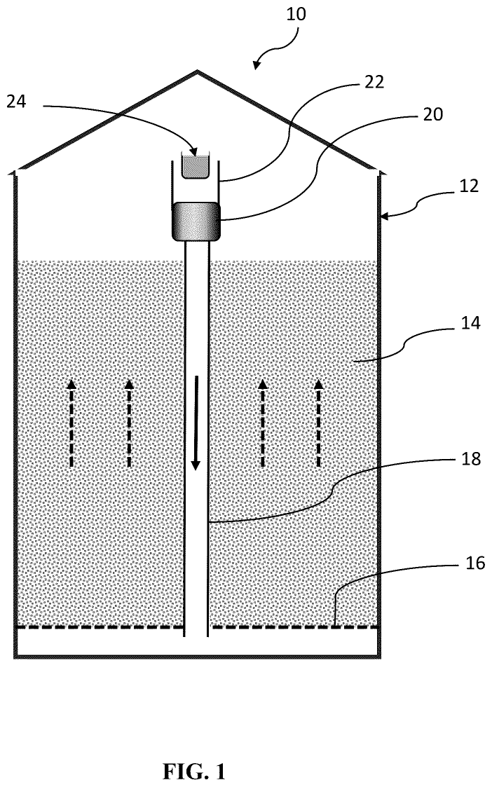

The figures show embodiments of the methods of using compositions described herein. FIG. 1 shows an exemplified embodiment 10 of treating a silo 12 loaded with grain 14. Grains 14 are supported on a porous platform 16. An air circulation pipe 18 is positioned vertically in the silo 12 with a bottom end extended near the bottom of the silo and upper end extended above stored grains 14. An air blower 20 is connected to the pipe 18. The air blower 20 has an inlet 22 for air. A chlorobenzene source 24 is positioned in the air blower inlet 22. The arrows in FIG. 1 indicate air flow directions during chlorobenzene fumigation. In this embodiment 10, air intake from the inlet 22 promote vaporization of chlorobenzene from the source 24 positioned in the inlet 22. Chlorobenzene vapor is blown downward through the pipe 18 to disperse at bottom space of the silo and forced to pass through the porous platform 16 and move upward through grains 14 to realize the objective of fumigating the stored grains 14.

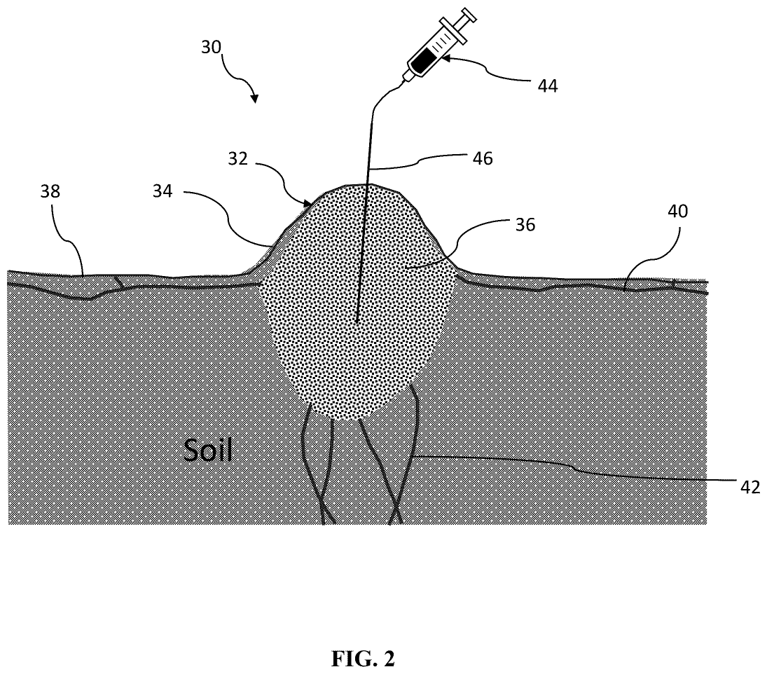

FIG. 2 shows an exemplified embodiment 30 of treating a fire ant colony. Fire ants form mound 32 which has a hard crest 34 covering excavated soil 32 piled above soil line 38. It also has shallow foraging tunnels 40 and tunnels 42 to water table. This exemplified embodiment 30 comprises a step of injecting chlorobenzene liquid using an injecting device 44 through a thin rigid tubing 46 into the mound. As chlorobenzene vaporizes, vapor would permeate through the mound and tunnels to kill ants in the mound and tunnels. The crest 34 and excavated soil 32 help to retain chlorobenzene vapor for a sufficient time to kill ants.

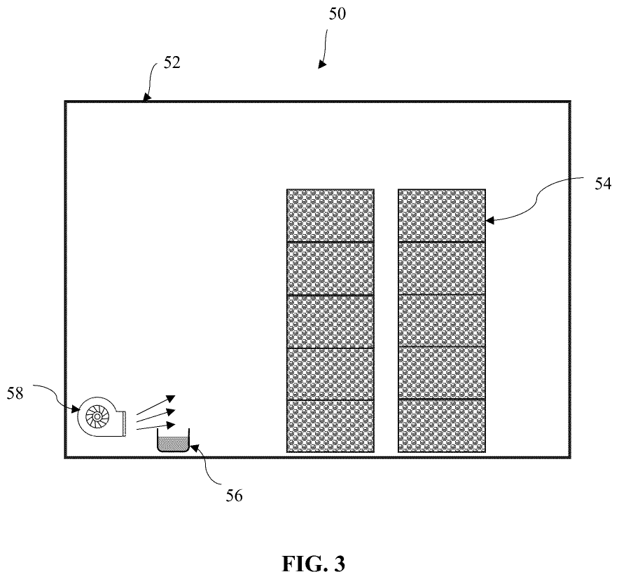

FIG. 3 shows another exemplified embodiment 50 of treating harvested fruits in boxes 54 in a cooler 52. A container with chlorobenzene 56 is positioned in front of air blower 58. The arrows show directions of air flow. Air currents from the air blower 58 carry vapors of chlorobenzene from the container 56 to permeate the inside space of the cooler and the boxes with fruits for a prescribed time period to accomplish the purpose of fumigating fruits with chlorobenzene vapor. Also disclosed herein are methods for killing insects (the term “insects” as used herein includes non-insects such as ticks, mites, spiders, centipedes, scorpions, chiggers, and solifugids) involving treating an object or area with an insect killing effective amount of a composition containing chlorobenzene and optionally a carrier (e.g., agronomically or physiologically or pharmaceutically acceptable carrier). The carrier component can be a liquid or a solid material.

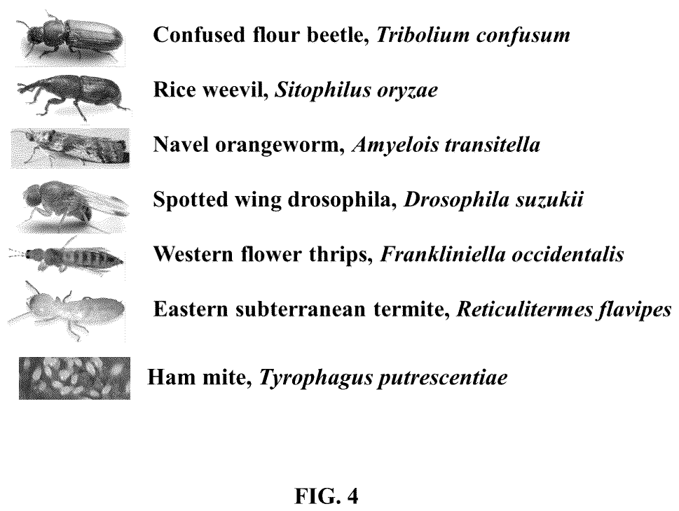

FIG. 4 shows images of seven exemplified pests treated in chlorobenzene fumigation treatments.

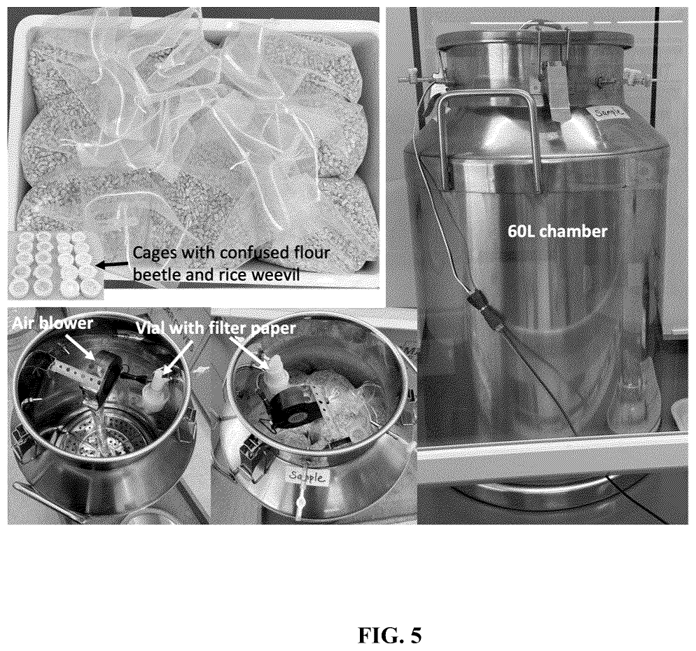

FIG. 5 shows photographs of chlorobenzene fumigation experiment set up in a 60-liter chamber. Amount of 20 kg feed corn in mash bags together with confused flour beetles and rice weevils in small cages were packed inside the chamber. The chamber has an air blower positioned vertically at the center of the chamber. A vial with a filter paper is positioned along the rim of the chamber to receive chlorobenzene injected through the port directly above the vial.

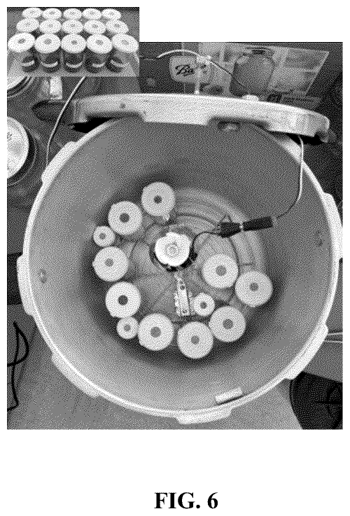

FIG. 6 shows an experiment set up for a 24 h fumigation with chlorobenzene. Vials containing navel orangeworm eggs, larvae, and pupae are positioned in a 21.8-liter fumigation chamber modified from a pressure cooker. A small container lined with filter paper is positioned at the center as a reservoir for chlorobenzene. An electric fan is positioned underneath of the container. To conduct a chlorobenzene fumigation, a certain volume of chlorobenzene liquid is deposited in the container. Then close the chamber with its lid and turn on the electric fan, and keep the chamber sealed for 24 h to complete the fumigation against navel orangeworm.

Carrier refers to a primary material used to allow a fumigant or pesticide to be dispersed effectively. Exemplified embodiments of a carrier that can be employed with the fumigation composition and methods used herein are a solvent or water emulsion mixed with a wettable powder before application, talc in a dust formulation, or the air that disperses the pesticide in an air blast application. The term “carrier” as used herein includes carrier materials such as those described below. As is known in the art, the vehicle or carrier to be used refers to a substrate such as a mineral oil, paraffin, silicon oil, water, membrane, sachets, disks, rope, vials, tubes, septa, resin, hollow fiber, microcapsule, activated carbon, nanoparticles, cigarette filter, gel, fiber, natural and/or synthetic polymers, elastomers or the like. All of these substrates have been used to controlled release effective amount of a composition containing the compounds disclosed herein in general and are well known in the art. Suitable carriers are well-known in the art and are selected in accordance with the ultimate application of interest. Agronomically acceptable substances include aqueous solutions, glycols, alcohols, ketones, esters, hydrocarbons halogenated hydrocarbons, polyvinyl chloride; in addition, solid carriers such as clays, laminates, cellulosic and rubber matrices and synthetic polymer matrices, or the like.

The term “matter” as used herein includes a commodity, structure, substrate or surface. In one aspect, a substrate is exemplified by soil which is the upper layer of earth that may be dug or plowed and in which plants grow. The terms “object” or “area” as used herein include any place where the presence of target pests is not desirable, including any type of premises, which can be out-of-doors, such as in farms, orchards, parks, yards, gardens, lawns, tents, camping bed nets, camping areas, forests, and so forth, or indoors, such as in barns, garages, commercial buildings, homes, silos, grain storage, and so forth, or any area where pests are a problem, such as in shipping or storage containers (e.g., luggage, bags, boxes, crates, etc.), packing materials, bedding, and so forth; objects in a domestic environments are exemplified by furniture, clothing and the like.

As used herein, the term “composition” refers to an administrable or useable form. Compositions often include additional ingredients other than the active ingredients, e.g. a pesticide or a fumigant, to improve the properties of the pesticide composition e.g. to make the composition more stable and/or easier to handle, store and/or apply. The compositions described herein may be “solid”, “liquid” or “slurry” compositions. “Solid” compositions are compositions that are solid (i.e. not liquid or gaseous) at 20° C. and atmospheric pressure. “Liquid” compositions are compositions that are liquid (i.e. not solid or gaseous) at 20° C. and atmospheric pressure. “Slurry” compositions are fluid mixtures of a solid with a liquid at 20° C. and atmospheric pressure

The amount of the compounds described herein, or compositions described herein especially chlorobenzene compositions and methods to be used will be at least an effective amount. The term “effective amount,” as used herein, means the minimum amount of the compound(s) or compositions needed to kill or disable insects, ticks, mites, spiders, centipedes, scorpions, chiggers, and solifugids when compared to the same area or object which is untreated or not fumigated. Of course, the precise amount needed will vary in accordance with the particular composition of chlorobenzene used and any carrier present in the composition; time or duration of application, the type of area or object to be treated; and the environment in which the area or object is located. The precise amount of the composition can easily be determined by one skilled in the art given the teaching of this application. For example, one skilled in the art could follow the procedures utilized below; the composition would be statistically significant in comparison to a negative control. The compounds described herein or compositions described herein to be used will be at least an effective amount of the compound or diluted solution of the compound; for fumigation the compounds used may have to be substantially pure (not mixed or adulterated with any other substance or material with a purity of 95-100%). Generally the concentration of the compounds in a carrier will be, but not limited to ranges such as, about 0.002% to about 15%, about 0.025% to about 10% (e.g., 0.025 to 10%, for example in an aqueous solution), preferably about 0.5% to about 4% (e.g., 0.5 to 4%), more preferably about 1% to about 2% (e.g., 1 to 2%). In one embodiment the concentration for effective treatment ranges from 10% to 100% of fumigant/volume of space treated. In some embodiments, other compounds (e.g., insect attractants or other insecticides known in the art) may be added to the composition provided they do not substantially interfere with the intended activity and efficacy of the composition; whether or not a compound interferes with activity and/or efficacy can be determined, for example, by the procedures known in the art and utilized below.

Percent by volume (% vol) stands for percent by volume and represents the concentration of a gas in a mixture. It is expressed as a percentage of the total volume. For example, if a gas concentration is 2% vol, it means that the gas makes up 2% of the total volume of the air or gas mixture.

The amount of the compounds described herein, or compositions described herein especially chlorobenzene compositions and methods to be used will be at least an effective amount also referred to as a dose. In various embodiments, exposing matter infested with a pest to fumigation vapors comprising chlorobenzene includes releasing an effective amount of chlorobenzene in liquid form an enclosed space containing the matter infested with the pest, wherein the effective amount of chlorobenzene is at least 25 μl/l of the enclosed space. The term μl/l is defined as the volume of liquid chlorobenzene in microliters to the volume of space treated in liters. Thus, 25 μl/l is 25 μl of chlorobenzene fumigant liquid made available per liter by volume of enclosed space infested by a pest. Methods described in various embodiments employ fumigation vapors which consist essentially of chlorobenzene vapor as the sole active ingredient. To maintain the effective vapor amount of fumigant vapor chlorobenzene at least 25 μl/l liquid chlorobenzene is applied to the enclosed space. In one embodiment, the effective amount of chlorobenzene quantity can range between 5 μl/l to 55 μl/l of liquid required to fumigate the enclosed space. In one embodiment, the effective amount of chlorobenzene quantity can range between 10 μl/l to 45 μl/l of liquid required to fumigate the enclosed space. In one embodiment, the effective amount of chlorobenzene quantity can range between 15 μl/l to 35 μl/l of liquid required to fumigate the enclosed space. In one embodiment, the effective amount of chlorobenzene quantity is at least 5 μl/l of liquid required to fumigate the enclosed space. In one embodiment, the effective amount of chlorobenzene quantity is at least 15 μl/l of liquid required to fumigate the enclosed space. In one embodiment, the effective amount of chlorobenzene quantity is at least 25 μl/l of liquid required to fumigate the enclosed space. In one embodiment, the effective amount of chlorobenzene quantity is at least 35 μl/l of liquid required to fumigate the enclosed space. In one embodiment, the effective amount of chlorobenzene quantity is at least 55 μl/l of liquid required to fumigate the enclosed space. In one embodiment, the effective amount of chlorobenzene quantity is at least 150 μl/l of liquid required to fumigate the enclosed space. In one embodiment, the effective amount of chlorobenzene quantity is at least 200 μl/l of liquid required to fumigate the enclosed space. In one embodiment, the effective amount of chlorobenzene vapor concentration in ambient air for fumigation is between about 100 ppm (0.01%) and 12,000 ppm (1.2%). In one embodiment effective chlorobenzene vapor concentrations for fumigation pest control in air ranges from about 200 ppm (0.02%) to 5000 ppm (0.5%).

The amount of the compounds described herein, or compositions described herein especially chlorobenzene compositions and methods to be used will be at least an effective amount also referred to as a dose. In various embodiments, exposing matter infested with a pest to fumigation vapors comprising chlorobenzene includes releasing an effective amount of chlorobenzene in an enclosed space containing the matter infested with the pest, wherein the effective amount of chlorobenzene can also be described in concentration terms including mg L⁻¹ or mg/liter (mg/l). The space is understood to be the space volume estimated by the dimensions of the space. For example, a room to be fumigated which has dimensions of 10 ft width, 10 feet length and 10 feet height would enclose a space of 1000 cubic feet which is equal to about 28,316 liters of volume. The estimated volume in different embodiments, may or may not take into account the volume of contents of a space, for example, any objects, furniture, goods, food materials, etc in the space (room) to be included in calculating the volume of space to be treated. The term mg/l or mg L⁻¹ (milligrams per liter) is defined as the amount of liquid chlorobenzene in milligrams to the volume of space treated in liters. Thus, 25 mg/l is 25 mg of chlorobenzene fumigant by weight made available per liter by volume of enclosed space infested by a pest. As described in the examples herein the given volume in liquid vaporizes and acts as fumigant. The amount of vapor being dependent on conditions of the fumigation site such as temperature, etc. In one embodiment, an effective treatment of a pest infestation by fumigation uses a chlorobenzene dose of about 0.01 mg L⁻¹ to about 160 mg L⁻¹. In one embodiment, an effective treatment of a pest infestation by fumigation consisting essentially of chlorobenzene is an effective dose of about 0.5 mg L⁻¹ to about 100 mg L⁻¹. In one embodiment, an effective treatment of a pest infestation by fumigation consisting of chlorobenzene is an effective dose of about 10 mg L⁻¹ to about 50 mg L⁻¹.

The amount of fumigant applied can also be optionally described in parts per million or percentage in embodiments described herein. The relative number of gas molecules present in a given volume of air, such as parts per million (ppm) or parts per billion (ppb). For example, a concentration of 1 ppm means that for every million air molecules, one of them is a fumigant molecule. The relative number of vapor/gas molecules of chlorobenzene present in a given volume of air, such as parts per million (ppm) or parts per billion (ppb).

The fumigation methods described herein are conducted to expose the pests treated for an effective amount of time. The time for effective treatment can range from 1 to 240 hours. The time for effective treatment can range from 1 to 24 hours. The time for effective treatment can range from 1 hour to 72 hours. The time for effective treatment can range from 6 hour to 72 hours.

The fumigation methods described herein are conducted to expose the pests treated at an effective temperature. The temperature for effective treatment can range from 32° F.-125° F. in one embodiment. The temperature for effective treatment can be range from 50-115° F. in one embodiment. The temperature for effective treatment can be range from 50-110° F. in one embodiment. The temperature for effective treatment can be range from 60-110° F. in one embodiment. The temperature for effective treatment can be range from 50-100° F. in one embodiment. The temperature for effective treatment can be 90° F. in one embodiment. The temperature for effective treatment can be 75° F. in one embodiment. The temperature for effective treatment can be 70° F. in one embodiment. The temperature for effective treatment can be 60° F. in one embodiment. The temperature for effective treatment can be 32° F. in one embodiment.

The term “vapor” as used herein describes a substance in gas phase at a temperature lower than its critical temperature.

The methods and chlorobenzene compositions described herein for fumigation can therefore be used for killing insects such as harmful or troublesome pests in agriculture, industry, health care, sanitation and or domestic settings exemplified by blood-sucking, stinging and biting insects, ticks and mites. The term “insects” as used herein include all stages of insect life cycle: adults, larvae, nymphs, pupae, and eggs. The term “insects” as used herein includes non-insects such as ticks, mites, spiders, centipedes, scorpions, chiggers, and solifugids.

Agriculturally important insects (e.g., insects that are harmful to agricultural plants and/or products such as grains, cereals and stored foods) include western flower thrips, Frankliniella occidentalis, spotted wing drosophila, Drosophila suzukii, brown marmorated stinkbug, Halyomorpha halys, emerald ash borer, Agrilus planipennis, gypsy moth, Lymantria dispar, pink hibiscus mealybug, Maconellicoccus hirsutus, Mediterranean fruit fly, Ceratitis capitata, plum curculio, Conotrachelus nenuphar, diamondback moth, Plutella xylostella, soybean aphid, Aphis glycines, cotton aphid, Aphis gossypii, sugarcane aphid, Melanaphis sacchari, indianmeal moth, Plodia interpunctella, bean weevil, Acanthoscelides obtectus, mountain pine beetle, Dendroctonus ponderosae, colorado potato beetle, Leptinotarsa decemlineata, Asian citrus psyllid, Diaphorina citri Kuwayama, light brown apple moth, Epiphyas postvittanaor, earworm, Helicoverpa armigera, potato white worm, Helicoverpa armigera, western corn rootworm, Diabrotica virgifera, lygus species (e.g., Lygus lineolaris, Lygus hesperus, Lygus rugulipennis), spotted lanternfly, Lycorma delicatula, khapra beetle, Trogoderma granarium, clothes moths, Tinea and Tineola species, cigarette beetle, Lasioderma serricorne, drugstore beetle, Stegobium paniceum, saw-toothed grain beetle, Oryzaephilus surinamensis, larder beetles Dermestes lardarius, mealworm beetle Tenebrio molitor, flour beetles (e.g. darkling beetle genera Tribolium or Tenebrio), carpet beetles (e.g. Anthrenus verbasci), weevils (e.g. rice weevil, maize weevil, and granary weevil in genus Sitophilus), bee louse Braula coeca, small hive beetle Aethina tumida, larval greater wax moth, Galleria mellonella, and tobacco hornworm, Manduca sexta.

Blood-sucking insects include mosquitoes (for example Aedes, Culex and Anopheles species), sand flies (for example Phlebotomus and Lutzomyia species such as Phlebotomus papatasi), owl gnats (Phlebotoma), blackfly (Culicoides species), buffalo gnats (Simulium species), biting flies (for example Stomoxys calcitrans), tsetse flies (Glossina species), horseflies (Tabanus, Haematopota and Chrysops species), house flies (for example Musca domestica and Fannia canicularis), meat flies (for example Sarcophaga carnaria), flies which cause myiasis (for example Lucilia cuprina, Chrysomyia chloropyga, Hypoderma bovis, Hypoderma lineatum, Dermatobia hominis, Oestrus ovis, Gasterophilus intestinalis and Cochliomyia hominovorax), bugs (for example Cimex lectularius, Rhodnius prolixus and Triatoma infestans), lice (for example Pediculus humanus, Haematopinus suis and Damalina ovis), louse flies (for example Melaphagus orinus), fleas (for example Pulex irritans, Cthenocephalides canis and Xenopsylla cheopis) and sand fleas (for example Dermatophilus penetrans).

Biting insects include cockroaches (for example Blattella germanica, Periplaneta americana, Blatta orientalis and Supella supellectilium), beetles (for example Sitophilus granarius, Tenebrio molitor, Dermestes lardarius, Stegobium paniceum, Anobium puntactum and Hylotrupes bajulus), termites (for example Reticulitermes lucifugus), bed bug (for example Cimex lectularius) and ants (for example Lasius niger).

Ticks include, for example, Ornithodorus moubata, Ixodes ricinus, Boophilus microplus and Amblyomma hebreum, and mites include, for example, Varroa destructor, Sarcoptes scabiei, Dermanyssus gallinae, Tetranychus urticae, Tetranychus cinnabarinus, and Oligonychus pratensis.

Spiders include, for example, Lactrodectus mactans, Loxosceles recluse, Tegenaria agrestis (Walckenaer), Achaearanea tepidariorum, Salticidae, Pholcus phalangioides, and Lycosa.

Centipedes include, for example, Scutigera coleoptrata.

Scorpions include, for example, Centruroides exilicauda, Centruroides vittatus, Hadrurus arizonensis, and Solifugae.

Solifugids include, for example, Solifugae.

Preferably, the blood-sucking and biting insects, ticks and mites include mosquitoes, sand flies, biting flies (e.g., black flies, biting midges), bed bugs, ticks, and fire ants (genus Solenopsis; for example black imported fire ants, S. richetri).

“Optional” or “optionally” means that the subsequently described event or circumstance may or may not occur, and that the description includes instances in which said event or circumstance occurs and instances where it does not. For example, the phrase “optionally comprising an insect attractant” means that the composition may or may not contain an insect attractant and that this description includes compositions that contain and do not contain an insect attractant.

Other compounds (e.g., insect attractants known in the art) may be added to the composition provided they do not substantially interfere with the intended activity and efficacy of the composition; whether or not a compound interferes with activity and/or efficacy can be determined, for example, by the procedures utilized below.

By the term “effective amount” of a compound or property as provided herein is meant such amount as is capable of performing the pest control or fumigation function for which an effective amount is expressed. As described herein, the exact amount required will vary from process to process, depending on recognized variables employed and the processing conditions observed. Thus, it is not possible to specify an exact “effective amount.” However, an appropriate effective amount may be determined by one of ordinary skill in the art using only routine experimentation. The effective amount may refer to a dose of a compound or a vapor concentration of a compound. The dose can be in a volume of liquid chemical per unit of volume of space such as μl/l or mg/l. The dose can also be in a volume or weight of liquid chemical per unit of surface area such as ml/m² or g/m² when a chemical is used to fumigate soil undercover. The vapor concentration can also be expressed in any other suitable equivalent units such as percentage or ppm (parts per million). The dose is the initial amount of chlorobenzene liquid per unit of space provided for fumigation. The vapor concentrations are results of vaporization of the dose of chlorobenzene liquid provided. The dose is a fixed value unless additional chlorobenzene is added during a fumigation. The vapor concentration is dynamic as chlorobenzene liquid vaporizes and resulting vapors condense or are adsorbed on surfaces of fumigated products and fumigation facility occur over time.

While this invention may be embodied in many different forms, there are described in detail herein specific preferred embodiments of the invention. The present disclosure provides exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments and characteristics described herein and/or incorporated herein. In addition, the invention encompasses any possible combination that also specifically excludes any one or some of the various embodiments and characteristics described herein and/or incorporated herein.

The amounts, percentages and ranges disclosed herein are not meant to be limiting, and increments between the recited amounts, percentages and ranges are specifically envisioned as part of the invention. All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10 including all integer values and decimal values; that is, all subranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions (e.g., reaction time, temperature), percentages and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. As used herein, the term “about” refers to a quantity, level, value, or amount that varies by as much as 10% to a reference quantity, level, value, or amount.

The term “consisting essentially of” defines specified materials or steps “and those that do not materially affect the basic and novel characteristic(s)” of the methods or compositions described here in their various embodiments. The invention illustratively disclosed herein suitably may be practiced in the absence of any element (e.g., method (or process) steps or composition components) which is not specifically disclosed herein.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

Having now generally described the compositions, methods of fumigation and other embodiments described herein, the same will be better understood by reference to certain specific examples, which are included herein only to further illustrate the embodiments and are not intended to limit the scope of the same as defined by the claims.

### EXAMPLES

Example 1: Chlorobenzene fumigations were conducted for control of six insect species and one mite species and they were: rice weevil, Sitophilus oryzae (Coleoptera: Curculionidae), confused flour beetle, Tribolium confusum (Coleoptera: Tenebrionidae), navel orangeworm, Amyelois transitella (Lepidoptera: Pyralidae), spotted wing drosophila, Drosophila suzukii (Diptera: Drosophilidae), western flower thrips, Frankliniella occidentalis (Thysanoptera: Thripidae), eastern subterranean termite, Reticulitermes flavipes (Blattodea: Rhinotermitidae), and ham mite, Tyrophagus putrescentiae (Schrank) (Acarina: Acaridae) (FIG. 2). Most fumigations were conducted in 1.9-liter glass jars. Confused flour beetle and rice weevil were fumigated in 1.9-liter jars and in 60-liter chambers with corn. Navel orangeworm was fumigated in 21.8 L chambers modified from pressure cookers.

Rice weevil and confused flour beetle were reared on pearled barley and wheat flour diet in jars, respectively. Western flower thrips were reared on lettuce plants in a greenhouse. Spotted wing drosophila was reared on an artificial diet in plastic cups. Workers of eastern subterranean termites were obtained from a commercial source. Ham mites were reared on dog food kibbles.

Each jar had a lid with a port equipped with a stopcock. A filter paper disc was clipped on the port underneath the lid with a metal clip. A silicone gasket ring was used under the lid to have an airtight seal of the jar. Insects of each species were collected in plastic vials and sealed with screened lids. The vials with insects were sealed in jars. Chlorobenzene was injected using a syringe with a long needle through the port on the lid to deposit chlorobenzene liquid onto the filter paper clipped on the port inside the jar. The jars were then kept at certain temperatures for specific durations in temperature chambers. At the end of each fumigation, the jars were ventilated in a fume hood, and the vials with insects were then recovered and stored for a certain length of time. Insect mortality was then scored. Chlorobenzene doses were recorded as microliter liquid per liter of chamber space (ul/l).

Confused flour beetle and rice weevil adults were collected separately in plastic vials from their prospective colonies. Each vial had about 50 adult insects without food. One vial with confused flour beetle adults and one vial with rice weevil adults were placed in a 1.9 L jar for a fumigation treatment. They were fumigated with chlorobenzene at 0 (control), 25, 50, 100, and 150 μl/l doses for 24 and 48 h at 21° C. Chlorobenzene vapor concentrations were measured during fumigation using detector tubes. After fumigation, insects were kept at room temperature overnight before being scored for mortality. Each treatment was replicated 3-5 times. For 24-h fumigations, the average vapor concentrations were about 400, 660, 1000, and 1800 ppm for 20, 50, 100, and 150 μl/l doses, respectively. For 48-h fumigations, the average vapor concentrations were about 400, 650, 800, and 1500 ppm for 20, 50, 100, and 150 μl/l doses, respectively. In 24-h fumigations, the 150 μl/l dose treatment (1800 ppm vapor concentration) resulted in 100% mortality of both confused flour beetle and rice weevil adults. In 48-h fumigations, the 100 μl/l dose treatment (800 ppm vapor concentration) resulted in 100% mortality of both species.

Spotted wing drosophila flies were collected in plastic vials (50/vial) without food and sealed with screened lids. One vial was placed in a 1.9 L jar for a fumigation treatment. Flies were fumigated with chlorobenzene at 0 (control), 10, 20, 30, and 50 μl/l doses for 3 h at 21° C. They were checked for mortality >3 h after fumigation. Each treatment was replicated 3-5 times. The 50 μl/l dose treatment resulted in 100% mortality of spotted wing drosophila flies.

Larvae and adults of western flower thrips were collected from infested lettuce plants in small vials each containing a piece of lettuce leaf (ca 20/vial) and stored in a refrigerator to cool them down. Vials were then set up in 1.9 L jars (5 vials/jar) and fumigated with chlorobenzene at 0 (control), 10, 25, 50, and 75 μl/l doses for 24 h at 2° C. Vapor concentrations of chlorobenzene were measured during fumigation. After fumigation, thrips were kept at 2° C. overnight before mortality was scored. Each dose was replicated 3 times. Average vapor concentrations of chlorobenzene were about 100, 230, 370, and 630 ppm for 10, 25, 50, and 75 μl/l doses, respectively. The 50 and 75 μl/l dose treatments resulted in 95.3 and 100% mortalities of western flower thrips.

Workers of eastern subterranean termites were obtained from a commercial source. They were set up in plastic vials containing infested wood materials and fumigated in 1.9-liter jars with chlorobenzene at 0 (control), 10, 20, 30, and 50 μl/l doses for 3 h at 21° C. After fumigation, vials with insects were held in an environmental chamber overnight before mortality was scored. Each dose was replicated 3 times. The 50 μl/l dose treatment resulted in 100% mortality of termite workers.

Ham mites on infested dog food kibbles were fumigated with chlorobenzene at different doses for 24 and 48 h at 21° C. Infested dog food kibbles were sealed individually in small plastic vials and fumigated in 1.9-liter jars for fumigation. For 24-h fumigations, chlorobenzene doses were 0 (control), 50, 100, and 200 μl/l. Doses for 48-h fumigations were 0 (control), 25, 50, 100, and 150 μl/l. A vial with moist paper towel was provided in each to maintain property humidity for mites. After fumigation, vials with ham mites were held at 21° C. overnight before mortality of larvae and adults was scored. Each dose was replicated 3 times. Chlorobenzene vapor concentrations were measured during each fumigation. The average vapor concentrations for 200 μl/l dose in 24-h fumigations and 150 μl/l dose in 48-h fumigations were about 2000 and 1700 ppm, respectively. In 24-h fumigations, the 200 μl/l dose treatment resulted in 99.96% mortality of ham mites. In 48-h fumigations, the 150 μl/l dose treatment resulted in 99.90% mortality of ham mites.

Example Effects of 24 h large-scale chlorobenzene fumigations on survival of all life stages of confused flour beetle and rice weevil

Procedure-Large-scale chlorobenzene fumigations of corn with confused flour beetle and rice weevil were conducted in a 60 L fumigation chamber. The chamber was modified from a 60 L diary pot with an added platform at bottom and a vertically positioned air blower to circulate air in the chamber (FIG. 3). A vial with filter paper was positioned near a port on the wall. A total of 20 kg corn was placed in 9 mesh bags. Confused flour beetle adults and other life stage in flour diet and rice weevil adults and other life stages in pearled barley were sealed in small plastic cages with mesh screens on top and bottom for air movement. One cage with confused four beetle culture medium with all life stages and one cage with all life stages of rice weevil were placed in each mesh bag. The bags were packed in the chamber in two layers. The last two containers with confused flour beetle and rice weevil respectively were placed on top of the corn bags. Ten cages for each species were set up to be fumigated. Five cages for each species were used as controls. The chamber was then placed in a fume hood. After the chamber was sealed, 30 ml chlorobenzene was injected into the vial in the chamber and the air blower was turned on to start a fumigation treatment. The fumigation treatment lasted 24 h at 21° C.

In each fumigation, chlorobenzene vapor concentrations were measured at 2, 4, 6, 9, 21,and 24 h of each treatment using chlorobenzene detector tubes. For each measurement, a 40 ml air sample from the headspace of the chamber was taken and diluted 50-fold in a 1.9 L glass jar. Then, chlorobenzene detectors with a range of 2-500 ppm were used to measure chlorobenzene concentrations. At the end of each fumigation, the lid of the fumigation chamber was removed, and the air blower was kept running for at least 2 h to ventilate the chamber. The corn bags were then removed and containers with insects were recovered. Insects together with diet from each cage were placed in a plastic vial. All adults were removed from each vial and mortality of adults was scored next day. All vials with diet containing other life stages were incubated at 25° C. in an environmental chamber to allow surviving immature individuals to develop and emerge as adults. The vials were checked weekly to count and remove emerged adults to assess mortality of immature stages until there was no adult emergence for two consecutive weeks. A total of three large-scale fumigation tests have been conducted.

Effective control of both confused flour beetle and rice weevil was also demonstrated in the large-scale fumigations of corn. Complete control of adults and immature life stages was achieved against confused flour beetle. For rice weevil, complete control of adults was achieved. For immature life stages of rice weevil, a total of 1645 adults emerged from 15 control vials and a total of 73 adults emerged from 30 treatment vials. Assuming equal numbers of vials for the control and the treatment, relative mortality of immature life stages measured by adults emerged was calculated to be 97.8% (Table 1). Chlorobenzene vapor concentrations increased over time and ranged from about 3500 at 2 h after the start of fumigation to about 5000 ppm near the end of fumigation. All chlorobenzene liquid vaporized by the end of each fumigation. The study demonstrated that chlorobenzene fumigation has good potential to be used in practice to control stored product insects.

TABLE 1
Effects of large-scale chlorobenzene fumigations
in a 60-liter chamber on survival of all life
stages of confused flour beetle and rice weevil

| | | | | Immature stages | |
|---|---|---|---|---|---|
| | | Adults | | | Relative |
| Insect | | | Mortality | Survived | mortality |
| species | Treatment | Total | (%) | to adults | (%) |
| Confused | Chlorobenzene | 931 | 100 | 0 | 100 |
| flour beetle | Control | 301 | 14.77 | 140 | 0 |
| Rice weevil | Chlorobenzene | 1294 | 100 | 73 | 97.8 |
| | Control | 910 | 6.18 | 1645 | 0 |

Example—Effects of 24 h chlorobenzene fumigation on mortality of navel orangeworm eggs and 6th instar larvae

Procedure-Navel orangeworm eggs, larvae, and pupae were fumigated with chlorobenzene for 24 h at 21° C. in 21.8L chambers modified from pressure cookers to determine effects on mortality. Each chamber has a fan to circulate air. A small container with a piece of filter affixed in it was positioned next to the fan in each chamber as a reservoir for chlorobenzene (FIG. 4). Egg sheet with eggs oviposited during the last 3 days was harvested and cut into small pieces each with about 50 eggs. One piece of egg sheet was placed in a small 49 ml plastic vial and sealed with a screened lid. Larvae of three different ages (2^{nd}, 4^{th}, and 6^{th}) were set up separately in 157 ml plastic vials each containing 3 g diet (10/vial). The vial was sealed with a screened lid. Three chlorobenzene does 50, 100, and 200 μl/l were tested in three chambers. They were achieved by adding 1, 2, and 4 ml of chlorobenzene in reservoirs in three fumigation chambers, respectively. Except for eggs that were only fumigated with chlorobenzene at 100 and 200 μl/l together with larvae and pupae, in each test, 5 vials of eggs, 9 vials of larvae (3 vials for each stage), and 3 vials of pupae were fumigated in one chamber. Controls were also set up for all life stages tested.

After chlorobenzene was added, the chamber was sealed and the fan was turned on to circulate air continuously for the 24 h duration of fumigation. Chlorobenzene detector tubes were used to measure chlorobenzene vapor concentrations 5-6 times between 2 h after start and before the end of fumigations. By the end of fumigation, all chlorobenzene liquid had vaporized in all three treatments. After fumigation, vials with larvae were held at 21° C. overnight before larval mortality was scored. For navel orangeworm eggs, diet was added in each vial and vials were incubated at 25° C. to allow all viable eggs to hatch. After over 10 days, neonate larvae were counted to estimate egg mortality. Pupae were also incubated at 25° C. in an environmental chamber to allow all viable pupae to develop into moths, and moths were then counted to determine pupal mortality. A total of three tests were conducted.

Chlorobenzene fumigations were effective against navel orangeworm. However, there were considerable differences among different life stages (Table 2). All eggs were killed at both doses and there was no single emergence of neonate larvae from fumigated eggs. There were no significant differences among three stages of larvae except that medium sized larvae (4^{th} instar) had highest mortality than 2^{nd} and 6^{th}. Therefore, the three age groups were pooled in calculating mortality. Larval mortality ranged from 20.4% to 95.9% from 50 to 200 μl/l dose range. Larvae were more tolerant to chlorobenzene fumigation than eggs based on their different mortality rates. Pupae were most tolerant among all life stages tested with the highest mortality of 43.5% at dose of 200 μl/l. Chlorobenzene vapor concentrations for 50, 100, and 200 μl/l doses were in the ranges of 1000-2260, 1500-5000, and 2750-5000 respectively.

TABLE 2
Effects of 24 h chlorobenzene fumigation in 21.8-liter chambers on
mortality of navel orangeworm eggs, 6^{th} instar larvae, and pupae

| | Eggs | | Larvae | | Pupae | |
|---|---|---|---|---|---|---|
| Chlorobenzene | | Total | | Mortality (%) | | Mortality (%) |
| dose (μl/l) | Total | neonates | Total | Mean ± SE | Total | Mean ± SE |
| 50 | | | 268 | 20.4 ± 3.6 | 108 | 7.4 ± 3.8 |
| 100 | 890 | 0 | 272 | 69.1 ± 4.6 | 108 | 20.4 ± 5.0 |
| 200 | 884 | 0 | 270 | 95.9 ± 1.3 | 108 | 43.5 ± 8.6 |
| Control | 887 | 370 | 270 | 4.8 ± 2.2 | 108 | 7.4 ± 2.6 |

We claim:

1. A method of controlling a pest by fumigation, the method comprising the step of exposing matter infested with the pest to fumigation vapors comprising chlorobenzene.

2. The method of claim 1 wherein the pest is a confused flour beetle, rice weevil, navel orange worm, spotted wing drosophila, western flower thrips, ham mites, or eastern subterranean termite.

3. The method of claim 1 wherein the fumigation vapors consist essentially of chlorobenzene.

4. The method of claim 1 wherein exposing matter infested with the pest to fumigation vapors comprising chlorobenzene includes releasing an amount of chlorobenzene to maintain a chlorobenzene vapor concentration between 0.01% and 1.2% in a fumigated space containing the matter infested with the pest.

5. The method of claim 1 wherein the concentration of chlorobenzene is about 200 ppm to 5000 ppm.

6. The method of claim 1 wherein exposing matter infested with the pest to fumigation vapors comprising chlorobenzene includes releasing an amount of chlorobenzene to maintain a chlorobenzene vapor concentration between 0.02% to 1.0% in a fumigated space containing the matter infested with the pest.

7. The method of claim 1 wherein exposing matter infested with the pest to fumigation vapors comprising chlorobenzene includes releasing an effective amount of chlorobenzene in an enclosed space containing the matter infested with the pest, wherein the effective amount of chlorobenzene quantity is equivalent to at least 25 μl/l of the enclosed space.

8. The method of claim 1 wherein exposing matter infested with the pest to fumigation vapors comprising chlorobenzene includes exposing the matter infested with the pest to the fumigation vapors for an effective time of fumigation, wherein the effective time of fumigation is at least 3 hours.

9. The method of claim 1 wherein exposing matter infested with the pest to fumigation vapors comprising chlorobenzene includes exposing the matter infested with the pest to the fumigation vapors for an effective time of fumigation, wherein the effective time of fumigation is about 24 hours.

10. The method of claim 1 wherein exposing matter infested with the pest to fumigation vapors comprising chlorobenzene includes exposing the matter infested with the pest to the fumigation vapors at an effective temperature for fumigation, wherein the effective temperature of fumigation is about 32° F.

11. The method of claim 1 wherein exposing matter infested with the pest to fumigation vapors comprising chlorobenzene includes exposing the matter infested with the pest to the fumigation vapors at an effective temperature for fumigation, wherein the effective temperature of fumigation is about 60° F.

12. The method of claim 1 wherein exposing matter infested with the pest to fumigation vapors comprising chlorobenzene includes exposing the matter infested with the pest to the fumigation vapors at an effective temperature for fumigation, wherein the effective temperature of fumigation is about 75° F.

13. The method of claim 1 wherein the matter infested with the pest includes soil.

14. The method of claim 17 wherein exposing matter infested with the pest to fumigation vapors comprising chlorobenzene includes covering the soil with an appropriate gas retaining tarp.

15. The method of fumigating of claim 1 wherein the matter infested with the pest includes stored products.

16. The method of claim 1 wherein the matter infested with the pest includes a storage space for goods and materials.

17. The method of claim 20 wherein the storage space is a shipping container, fumigation chamber, tent, archive, tunnel, vault, hotel room, granary or cellar.

18. A fumigation mixture consisting of chlorobenzene in air wherein the concentration of chlorobenzene is about 100 ppm to 12000 ppm in air.

19. A fumigation mixture as claimed in claim 19 wherein the concentration of chlorobenzene is about 200 ppm to 5000 ppm.

20. A fumigation mixture of claim 19 wherein the fumigant includes a carrier.

21. A fumigation mixture of claim 19 wherein the carrier is a solid or liquid carrier.

22. A fumigation mixture of claim 19 wherein the chlorobenzene is in solution.

23. The fumigation mixture of claim 19 wherein the solution is an organic or aqueous solution.

24. The fumigation mixture of claim 19 wherein the chlorobenzene has fumigation vapors consisting of chlorobenzene vapors mixed with ambient air and impurities ordinarily associated therewith commercially available chlorobenzene product.
